(19) United States
(12) Patent Application Publication
(10) Pub. No.: US 2003/0033206 A1
(43) Pub. Date: Feb. 13, 2003

(54) Vending machine and method for marketing a computer readable work of art

(75) Inventor: Sharon Moshe, Kfar Saba (IL)

Correspondence Address: BROWDY AND NEIMARK, P.L.L.C., 624 NINTH STREET, NW, SUITE 300, WASHINGTON, DC, 20001-5303, US

(73) Assignee: Song Surprise Ltd.,, Kfar Saba (IL)

(21) Appl. No.: 09/922,922

(22) Filed: Aug. 7, 2001

(51) Int. Cl. G06F 17/60

(52) U.S. Cl. 705/26

(57) ABSTRACT

A vending machine for marketing a computer readable work of art stored on or in association therewith at a point of sale, wherein personal data relating to a specific recipient is received by the vending machine, which uses the personal data to format in real time a personalized computer readable message created by a sponsor dedicating the computer readable work of art to the specific recipient without requiring real time interaction by the sponsor. The sponsor may be the author of the work of art or a person who purchases the personalized work or art as a gift for the recipient. The personalized computer readable message is then merged with the computer readable work of art in real time so as to form a composite computer readable data string that may be dispensed by the vending machine. The composite computer readable data string may be copied to a portable data carrier for dispensing by the vending machine, or it may be communicated to the specified recipient electronically. If desired, the computer readable work of may be art stored on a server remote from the vending machine and the server may personalize the computer readable message.

### FIELD OF THE INVENTION

This invention relates to personalization of computer readable works of art.

### BACKGROUND OF THE INVENTION

The need to personalize audio and other data is addressed in the prior art. For example, reference may be made to U.S. Pat. No. 6,067,348 (Hibbeler) published May 23, 2000 disclosing a method and apparatus for personalizing a message for a large number of recipients whose names and associated phone numbers are stored in call list. The method for creating the personalized message comprises storing greeting segments in a storage area in a predetermined order, assigning a unique index number to each greeting segment of the plurality of greeting segments, recalling a greeting segment from the storage area using the unique index number, and combining the greeting segment with a message body to form a personalized message.

U.S. Pat. No. 5,546,316 (Buckley et al.) published Aug. 13, 1996 discloses a vending machine including therein computer equipment programmed to facilitate a customer's creation from among types of products to be delivered and the desired mode of personalization thereof and to deliver a completed personalized product to a receptacle from which the customer may remove it. The vending machine is particularly suited for the personalization and delivery of greeting cards, allowing a personalized text greeting to be formatted for a recipient and printed using selected print attributes.

U.S. Pat. No. 5,915,734 (Minehart) published Jun. 29, 1999 discloses a personalized, user assembled greeting card that includes a manually usable holder for detachably receiving a sound recording. The sound recording is user selected from a variety of available sound recordings, and is placed by the user in the holder for manual detachment by a recipient.

U.S. Pat. No. 5,513,116 (Buckley) published Apr. 30, 1996 discloses a machine for vending greeting cards or other personalized or customized products including audio and video presentations of available products and options available to a customer, provisions for payment and apparatus for automatic delivery of products.

It emerges from the above-mentioned patents that machines for vending personalized greetings are known, be they textual, audio or visual. Likewise, techniques are known for personalizing generic messages, typically by processing message segments so as to create a composite personalized message.

Works of art such as sound recordings are mass-produced and sold to the public, typically as cassettes or discs. Single tracks may also be sold in this manner, but they too are directed to the mass market. It has never been suggested to sell single or multiple tracks of an artist to a target audience and to personalize the recording for the target audience by prefixing an audio greeting to the target audience. It would serve as an added incentive to purchase an artist's recording if it were personalized for the end user. This would be all the more true if the audio recording were personalized by a message recorded by the artist himself and dedicated to the recipient. This would also be commercially attractive to the artist since it would enable his or her recordings to be targeted to individuals rather than mass audiences and thus reach users who might not otherwise purchase the artist's recordings. It would also add value to the artist's recordings and enable them to be sold at a higher price than would otherwise be possible.

### SUMMARY OF THE INVENTION

It is therefore an object of the invention to provide a method for marketing a computer readable work of art stored on or in association with a vending machine at a point of sale and a vending machine, which allow for the computer readable work of art to be personalized for a specific recipient.

According to a first aspect of the invention there is provided a method for promoting an artist, the method comprising the following steps:

(a) receiving personal data entered into a vending machine at a point of sale, said personal data including details of a specific recipient to whom computer readable data produced in the guise of said artist is to be sent, and

(b) using said personal data to format in real time a personalized computer readable message created in the guise of the artist and dedicated to the specific recipient so as to form a computer readable data string that may be dispensed by the vending machine without requiring real time interaction by the artist.

Within the context of the invention and the appended claims, the term “in the guise of the artist” is intended to mean that the computer readable message appears as though it originates from the artist, which of course it may well do. Thus, in the case of an audio message it sounds as though it was vocalized by the artist. In the case of a text message it looks as though it was hand-written or drawn by the artist. Typically, the message is built from actual message fragments (vocal, textual or pictorial or any combination thereof) pre-recorded by the artist. In saying this, the invention does not preclude the possibility that the message is actually an imitation produced either by an impersonation or via computer software, such as voice synthesis and the like.

According to a second aspect of the invention there is provided a method for marketing a computer readable work of art stored on or in association with a vending machine at a point of sale, the method comprising the following steps:

(a) receiving personal data including details of a specific recipient,

(b) using said personal data to format in real time a personalized computer readable message created by a sponsor dedicating the computer readable work of art to the specific recipient without requiring real time interaction by the sponsor, and

(c) merging the personalized computer readable message with the computer readable work of art in real time so as to form a composite computer readable data string that may be dispensed by the vending machine.

According to a third aspect of the invention there is provided a method for marketing a computer readable work of art stored on or in association with a vending machine at a point of sale, the method comprising the following steps:

(a) receiving personal data including details of a specific recipient,

(b) using said personal data to format in real time a personalized computer readable message created by a sponsor dedicating the computer readable work of art to the specific recipient without requiring real time interaction by the sponsor, and

(c) merging the personalized computer readable message with the computer readable work of art in real time so as to form a composite computer readable data string that may be dispensed by the vending machine.

According to a fourth aspect of the invention there is provided a vending machine for marketing a computer readable work of art, the vending machine comprising:

a user interface for receiving personal data including details of a specific recipient,

a message formatter for using said personal data to format in real time a personalized computer readable message created by a sponsor dedicating the computer readable work of art to the specific recipient without requiring real time interaction by the sponsor, and

a merging unit for merging the personalized computer readable message with the computer readable work of art in real time so as to form a composite computer readable data string that may be dispensed by the vending machine.

The vending machine according to the invention may include a memory for storing the personalized computer readable message. Alternatively, it may include a communication port for coupling to a remote server storing the personalized computer readable message. A copying unit may be provided for copying data representative of the composite computer readable data string to a portable data carrier for dispensing by the vending machine. The sponsor may be the author of the work of art or a person who purchases the personalized work or art as a gift for the recipient.

### BRIEF DESCRIPTION OF THE DRAWINGS

In order to understand the invention and to see how it may be carried out in practice, a preferred embodiment relating to the marketing of an audio work of art will now be described, by way of non-limiting example only, with reference to the accompanying drawings, in which:

FIG. 1 is a flow diagram showing the principal operating steps carried out by a method according to the invention for marketing an audio work of art;

FIG. 2 is a flow diagram showing the principal operating steps used to personalize the audio work of art;

FIG. 3 is a block diagram showing functionally a system including a vending machine according to the invention for marketing an audio work of art; and

FIG. 4 is a flow diagram showing the principal operating steps carried out by a method according to the invention for promoting an artist.

### DETAILED DESCRIPTION OF SPECIFIC EMBODIMENTS

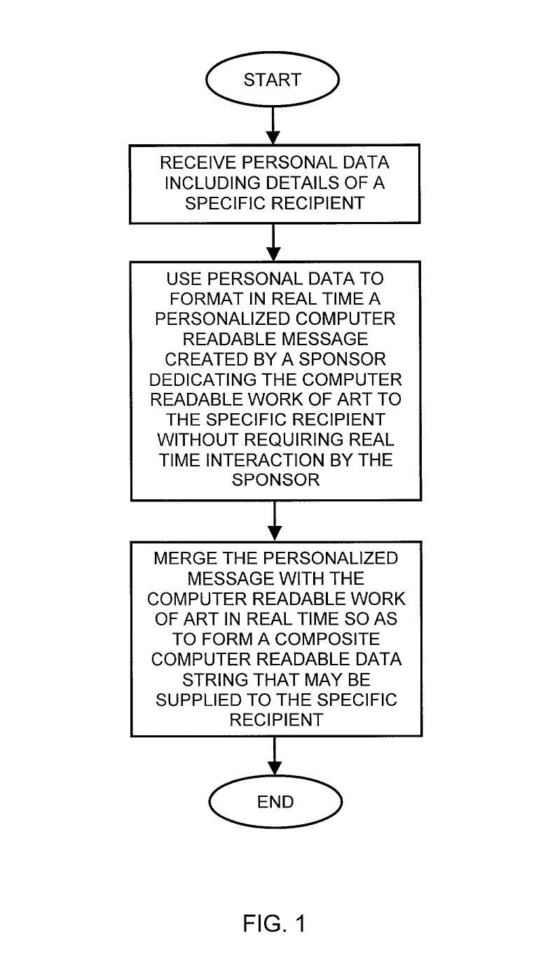

FIG. 1 is a flow diagram showing the principal operating steps carried out by a method according to the invention for marketing an audio work of art stored on or in association with a vending machine at a point of sale. Personal data relating to a specific recipient is entered via a user interface to a vending machine situated at the point of sale. The personal data is used to format in real time a personalized audio message created by an author of the audio work of art for the specific recipient without requiring real time interaction by the author. The personalized audio message is then merged with the audio work of art in real time so as to form a composite audio data string that may be supplied to the recipient.

According to one embodiment of the invention, the vending machine is completely standalone and the personalized audio message is stored in the vending machine. Alternatively, the vending machine may be coupled to a remote server, which receives the personal data from the vending machine, personalizes the audio work of art and uploads the composite audio data string to the vending machine. The composite audio data string may be directly communicated to the recipient electronically, for example by electronic mail. However, more typically data representative of the composite audio data string is copied by the vending machine to a portable storage medium for dispensing immediately by the vending machine.

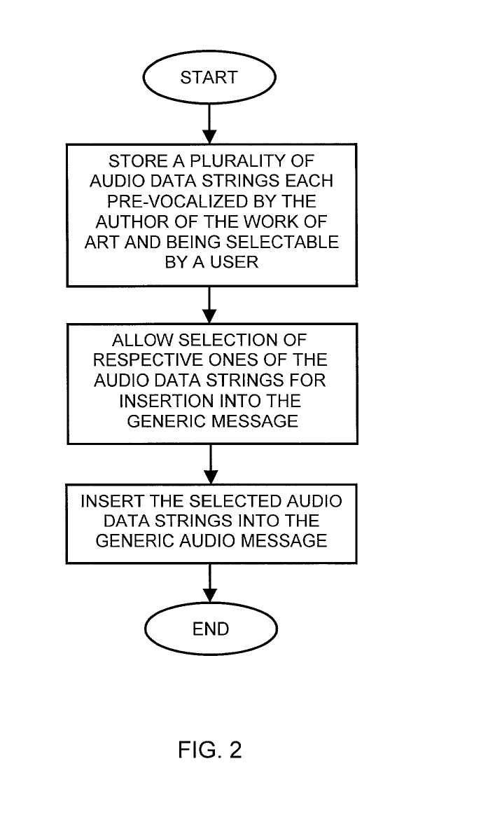

The manner in which the audio work of art is personalized is not itself a feature of the invention. However, FIG. 2 shows suitable method steps wherein is there is stored a generic audio message created by the author includes gaps for inserting personalized audio data therein. Respective audio data strings corresponding to the personalized audio data are inserted into the gaps for personalizing the generic audio message for the specific recipient. In order to create a custom-made CD that includes an audio greeting and a song, the user must insert some information about the intended recipient, as well as select the greeting and song appropriate for the occasion. To this end, the vending machine is provided with a user interface that allows the user to select customizable data from various sequential easy to use choice-menus displayed on a display screen. Typical personal information that may be entered by the user includes:

Type of relationship—friend, wife, brother, etc.

Type of occasion—Birthday, Wedding, Graduation, etc.

Name and age of the receiver of the CD (age is needed for birthday occasions only).

Name of the dedicator (usually the customer).

A computer (typically within the vending machine) processes the data and seamlessly integrates all the gathered information into the ready-made audio greeting that was selected by the user. The last action of the ordering process is for the user to choose from a collection of songs that s/he would like to dedicate. Within five minutes from the end of the ordering process, the vending machine dispenses a CD with a song and added to the beginning and/or end of the song is the custom-made audio greeting.

The personalized audio message may comprise pre-recorded audio strings or vocally synthesized audio strings. In the case that the audio strings are synthesized, they may be partially or wholly synthesized from text data. The audio data strings that are inserted into the generic message may be at least partially pre-recorded. In such case, the manner in which the personal message is created may include:

i) storing a plurality of audio data strings each pre-created by said author and being selectable by a user,

ii) allowing selection of respective ones of the audio data strings for insertion into the generic message, and

iii) inserting the selected audio data strings into the generic audio message.

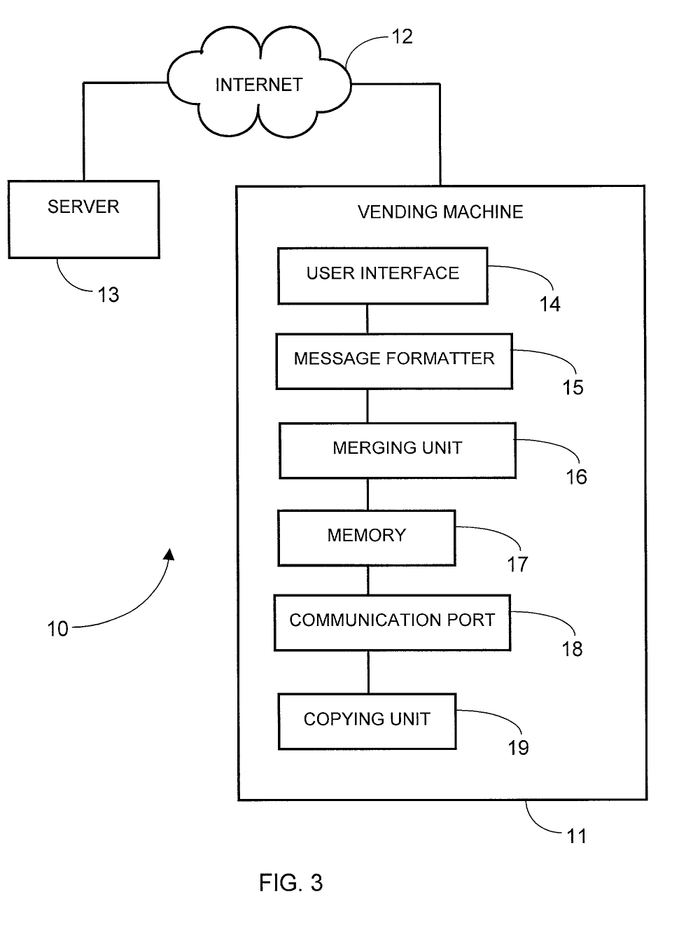

FIG. 3 shows functionally a system 10 including a vending machine 11 coupled via the Internet 12 to a remote server 13 for marketing an audio work of art. The vending machine 10 comprises a user interface 14 for receiving personal data relating to a specific recipient, and a message formatter 15 for using the personal data to format in real time a personalized audio message created by an author of the audio work of art for the specific recipient without requiring real time interaction by the author. A merging unit 16 is coupled to the message formatter 15 for merging the personalized audio message with the audio work of art in real time so as to form a composite audio data string that may be dispensed immediately by the vending machine. A memory 17 is provided for storing the audio work of art and/or the personalized audio message. If desired, the audio work of art and/or the personalized audio message may be stored on the remote server 13 coupled to the vending machine 10 via a communication port 18 therein.

The vending machine may further include a copying unit 19 coupled to the memory 16 for copying data representative of the composite audio data string to a portable data carrier for dispensing by the vending machine.

According to the invention as described so far, a computer readable message is merged with a computer readable work of art so as to form a composite computer readable data string that may be copied to a computer readable medium or otherwise conveyed to a specific recipient. However, the same principle can also be applied to the creation of a message in the guise of an artist for sending to a recipient and thereby promoting the artist. Optionally, a work of art of the artist can be merged with the message as explained above with reference to FIGS. 1 and 2 of the drawings.

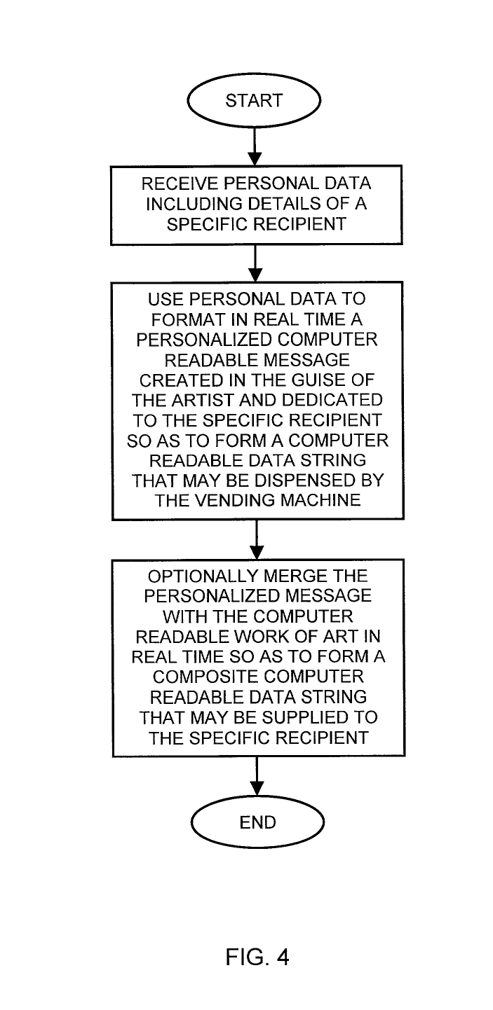

FIG. 4 shows the principal operating steps carried out by such a method for promoting an artist. Personal data is entered into a vending machine at a point of sale, including details of a specific recipient to whom computer readable data produced in the guise of the artist is to be sent. The personal data is used to format in real time a personalized computer readable message created in the guise of the artist and dedicated to the specific recipient. The resulting computer readable data string may be dispensed by the vending machine without requiring real time interaction by the artist. It may also be sent to the recipient by e-mail or via any other form of data communication.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

The invention also encompasses a portable data carrier bearing thereon a personalized computer readable message that may be merged with a computer readable work of art according to the method of the invention.

It will be appreciated that modifications may be made to the preferred embodiments without departing from the scope of the invention as claimed. For example, whilst the server shown in FIG. 3 is a web server, it will be understood that the invention may equally well be carried out over an intranet or any communications network where the vending machine is connected to a remote server.

The invention has been described with particular reference to the creation of a CD bearing one or more songs accompanied by an audio greeting presented by the songwriter. However, the principle of the invention is clearly applicable in other circumstances also. For example, the “work of art” may be a team song celebrating a sports team and may be accompanied by a personal, custom-made audio greeting delivered by one of the team players. It may likewise be a lecture delivered by a well-known personality and accompanied by a personal, custom-made audio greeting by that personality. It may also include a computerized book or section thereof or computer software including computer games and photo images all with an audio greeting by the author. The “work of art” may also include one or more songs or lectures etc. and the personalized greeting may be merged at the beginning or at the end or even between songs etc. Thus the work of art does not necessarily have to be audio and any work of art that is readable by computer is contemplated by the invention.

Finally, while in the preferred embodiment, the audio greeting is delivered by the performing artist, it could equally well be delivered by the purchaser of the CD who dedicates it to the recipient in his or her own voice. The greeting does not have to be audio. For example, the work of art could be a photograph of a celebrity and the personalized message could be a greeting hand-written by the celebrity and rendered in computer readable format. Likewise, the composite computer readable data string may include data in a mixture of computer readable formats. For example, a team photograph may be accompanied by an audio message or an autographed photograph of a songwriter may accompany one or more of his or her songs, and so on.

1. A method for promoting an artist, the method comprising the following steps:
(a) receiving personal data entered into a vending machine at a point of sale, said personal data including details of a specific recipient to whom computer readable data produced in the guise of said artist is to be sent, and
(b) using said personal data to format in real time a personalized computer readable message created in the guise of the artist and dedicated to the specific recipient so as to form a computer readable data string that may be dispensed by the vending machine without requiring real time interaction by the artist.

2. The method according to claim 1, further including:
merging the computer readable data string with a computer readable work of art in real time so as to form a composite computer readable data string that may be dispensed by the vending machine.

3. The method according to claim 2, wherein the computer readable work of art is stored in the vending machine.

4. The method according to claim 1, being carried out by a remote server coupled to the vending machine.

5. The method according to claim 4, further including the following step carried out by the remote server:
uploading the computer readable data string to the vending machine.

6. The method according to claim 1, further including:
copying the computer readable data string to a portable data carrier for dispensing immediately by the vending machine.

7. The method according to claim 1, further including:
transmitting the computer readable data string to a remote repository for access by the specific recipient.

8. The method according to claim 1, wherein step (b) includes:
i) obtaining a generic computer readable message created by said artist and including gaps for inserting personalized computer readable data therein, and
ii) inserting into the gaps respective computer readable data strings corresponding to said personalized computer readable data for personalizing the generic computer readable message for the specific recipient.

9. The method according to claim 1, wherein the personalized computer readable message comprises pre-recorded computer readable strings.

10. The method according to claim 1, wherein the personalized computer readable message comprises vocally synthesized computer readable strings.

11. The method according to claim 8, wherein the computer readable data strings are vocally synthesized.

12. The method according to claim 8, wherein the computer readable data strings are at least partially pre-recorded.

13. The method according to claim 12 further including:
i) storing a plurality of computer readable data strings each pre-created by said artist and being selectable by a user,
ii) allowing selection of respective ones of the computer readable data strings for insertion into the generic message, and
iii) inserting the selected computer readable data strings into the generic computer readable message.

14. A method for promoting an artist, the method comprising the following steps carried out by a vending machine at a point of sale:
(a) receiving personal data including details relating to a specific recipient,
(b) uploading the personal data to a server coupled to the vending machine,
(c) receiving from the server in real time a computer readable data string including a personalized computer readable message created in the guise of the artists and being dedicated to the specific recipient without requiring real time interaction by the artist, and
(d) supplying the computer readable data string to the specific recipient.

15. A program storage device readable by machine, tangibly embodying a program of instructions executable by the machine to perform method steps for promoting an artist, the method comprising the following steps:
(a) receiving personal data entered into a vending machine at a point of sale, said personal data including details of a specific recipient to whom computer readable data produced in the guise of said artist is to be sent, and
(b) using said personal data to format in real time a personalized computer readable message created in the guise of the artist and dedicated to the specific recipient so as to form a computer readable data string that may be dispensed by the vending machine without requiring real time interaction by the artist.

16. A computer program product comprising a computer useable medium having computer readable program code embodied therein for promoting an artist, the computer program product comprising:
computer readable program code for causing the computer to receive personal data entered into a vending machine at a point of sale, said personal data including details of a specific recipient to whom computer readable data produced in the guise of said artist is to be sent, and
computer readable program code for causing the computer to use said personal data to format in real time a personalized computer readable message created in the guise of the artist and dedicated to the specific recipient so as to form a computer readable data string that may be dispensed by the vending machine without requiring real time interaction by the artist.

17. A vending machine for promoting an artist, the vending machine comprising:
a user interface for receiving personal data including details relating to a specific recipient, and
a message formatter for using said personal data to format in real time a personalized computer readable message created in the guise of the artist and being dedicated to the specific recipient so as to form a computer readable data string that may be dispensed by the vending machine without requiring real time interaction by the artist.

18. The vending machine according to claim 15 further comprising:
a merging unit coupled to the message formatter for merging the personalized computer readable message with a computer readable work of art in real time so as to form a composite computer readable data string that may be dispensed by the vending machine.

19. The vending machine according to claim 18 further including a memory for storing the computer readable work of art.

20. The vending machine according to claim 15 further including a memory for storing the personalized computer readable message.

21. The vending machine according to claim 18 further including a communication port for coupling to a remote server storing the computer readable work of art.

22. The vending machine according to claim 15 further including a communication port for coupling to a remote server storing the personalized computer readable message.

23. The vending machine according to claim 15 further including a copying unit for copying data representative of the computer readable data string to a portable data carrier for dispensing by the vending machine.

24. The vending machine according to claim 18 further including a copying unit for copying data representative of the computer readable data string to a portable data carrier for dispensing by the vending machine.

25. A portable data carrier bearing thereon a personalized computer readable message that is created according to the method of claim 1.

26. A method for marketing a computer readable work of art stored on or in association with a vending machine at a point of sale, the method comprising the following steps:
(a) receiving personal data including details relating to a specific recipient,
(b) using said personal data to format in real time a personalized computer readable message created by a sponsor dedicating the computer readable work of art to the specific recipient without requiring real time interaction by the sponsor, and
(c) merging the personalized computer readable message with the computer readable work of art in real time so as to form a composite computer readable data string that may be dispensed by the vending machine.

27. The method according to claim 26 wherein the computer readable work of art is stored in the vending machine.

28. The method according to claim 26, wherein the sponsor is an author of the computer readable work of art.

29. The method according to claim 26 wherein the sponsor is a purchaser of the composite computer readable data string.

30. The method according to claim 26 being carried out by a remote server coupled to the vending machine.

31. The method according to claim 30 further including the following step carried out by the remote server:
uploading the composite computer readable data string to the vending machine.

32. The method according to claim 26 further including:
copying the composite computer readable data string to a portable data carrier for dispensing immediately by the vending machine.

33. The method according to claim 26 further including:
transmitting the composite computer readable data string to a remote repository for access by the specific recipient.

34. The method according to claim 26 wherein step (b) includes:
i) obtaining a generic computer readable message created by said sponsor and including gaps for inserting personalized computer readable data therein, and
ii) inserting into the gaps respective computer readable data strings corresponding to said personalized computer readable data for personalizing the generic computer readable message for the specific recipient.

35. The method according to claim 26 wherein the personalized computer readable message comprises pre-recorded computer readable data strings.

36. The method according to claim 26 wherein the personalized computer readable message comprises vocally synthesized computer readable strings.

37. The method according to claim 35 wherein the computer readable data strings are vocally synthesized.

38. The method according to claim 36 wherein the computer readable data strings are at least partially pre-recorded.

39. The method according to claim 34 further including:
iii) storing a plurality of computer readable data strings each pre-created by said sponsor and being selectable by a user,
iv) allowing selection of respective ones of the computer readable data strings for insertion into the generic message, and
v) inserting the selected computer readable data strings into the generic computer readable message.

40. A method for marketing a computer readable work of art stored on or in association with a vending machine at a point of sale, the method comprising the following steps carried out by the vending machine:
(a) receiving personal data including details relating to a specific recipient,
(b) uploading the personal data to a server coupled to the vending machine,
(c) receiving from the server in real time a composite computer readable data string including a personalized computer readable message created by a sponsor dedicating the computer readable work of art to the specific recipient and being merged with the work of art without requiring real time interaction by the sponsor, and
(d) supplying the composite computer readable data string to the specific recipient.

41. A program storage device readable by machine, tangibly embodying a program of instructions executable by the machine to perform method steps for marketing a computer readable work of art stored on or in association with a vending machine at a point of sale, the method comprising the following steps:
(a) receiving personal data including details relating to the specific recipient,
(b) using said personal data to format in real time a personalized computer readable message created by a sponsor dedicating the computer readable work of art to the specific recipient without requiring real time interaction by the sponsor, and
(c) merging the personalized computer readable message with the computer readable work of art in real time so as to form a composite computer readable data string that may be dispensed by the vending machine.

42. A computer program product comprising a computer useable medium having computer readable program code embodied therein for marketing a computer readable work of art stored on or in association with a vending machine at a point of sale, the computer program product comprising:
computer readable program code for causing the computer to receive personal data including details relating to the specific recipient,
computer readable program code for causing the computer to use said personal data to format in real time a personalized computer readable message created by a sponsor dedicating the computer readable work of art to the specific recipient without requiring real time interaction by the sponsor, and
computer readable program code for causing the computer to merge the personalized computer readable message with the computer readable work of art in real time so as to form a composite computer readable data string that may be dispensed by the vending machine.

43. A vending machine for marketing a computer readable work of art, the vending machine comprising:
a user interface for receiving personal data including details relating to a specific recipient,
a message formatter for using said personal data to format in real time a personalized computer readable message created by a sponsor dedicating the computer readable work of art to the specific recipient without requiring real time interaction by the sponsor, and
a merging unit coupled to the message formatter for merging the personalized computer readable message with the computer readable work of art in real time so as to form a composite computer readable data string that may be dispensed by the vending machine.

44. The vending machine according to claim 43 further including a memory for storing the computer readable work of art.

45. The vending machine according to claim 43 further including a memory for storing the personalized computer readable message.

46. The vending machine according to claim 43 further including a communication port for coupling to a remote server storing the computer readable work of art.

47. The vending machine according to claim 43 further including a communication port for coupling to a remote server storing the personalized computer readable message.

48. The vending machine according to claim 43 further including a copying unit for copying data representative of the composite computer readable data string to a portable data carrier for dispensing by the vending machine.

49. A portable data carrier bearing thereon a personalized computer readable message that is merged with a computer readable work of art according to the method of claim 26
